(19) United States
(12) Patent Application Publication
(10) Pub. No.: US 2025/0147259 A1
(43) Pub. Date: May 8, 2025

(54) FIBER OPTIC DISTRIBUTION MODULE ASSEMBLY

(71) Applicant: HUBER+SUHNER AG, CH-9100 HERISAU (CH)

(72) Inventor: Lukas PFISTER, Herisau (CH)

(73) Assignee: HUBER+SUHNER AG, CH-9100 HERISAU (CH)

(21) Appl. No.: 18/908,150

(22) Filed: Oct. 7, 2024

(30) Foreign Application Priority Data
Nov. 8, 2023 (CH) 001231//2023

(51) Int. Cl. G02B 6/44; G02B 6/38

(52) U.S. Cl. CPC G02B 6/4455; G02B 6/3825; G02B 6/4452; G02B 6/4454

(57) ABSTRACT

A fiber optic distribution module assembly for installation in a fiber optic distribution rack includes a fiber optic distribution module with a tray extending from a fiber entry port to a fiber exit port and including a fiber management area. The fiber optic distribution module assembly further includes a fiber optic cable, such as a fiber optic ribbon, which is arranged within the fiber optic distribution module and extends from the fiber entry port via the fiber management area to the fiber exit port. The fiber optic cable arranged in loops whereby, in a top view onto the tray, at least one first loop extends from the fiber entry port towards the fiber exit port and is arranged clockwise and at least a second loop extends from the fiber exit port towards the fiber entry port and is arranged counterclockwise, or vice versa.

### CROSS-REFERENCE TO RELATED APPLICATIONS

Swiss Patent Application No. CH 001231/2023, filed 8 Nov. 2023, the priority document corresponding to this invention, to which a foreign priority benefit is claimed under Title 35, United States Code, Section 119, and its entire teachings are incorporated, by reference, into this specification.

### FIELD OF THE DISCLOSURE

The present disclosure relates to a fiber optic distribution module assembly, in particular for installation in a fiber optic distribution rack, as well as a mounting aid and a method for assembling the fiber optic distribution module assembly.

### BACKGROUND OF THE DISCLOSURE

U.S. Pat. No. 6,424,781 B1 published on 23.07.2002 in the name of ADC TELECOMMUNICATIONS INC relates to a fiber optic telecommunications frame including rotatable panels having front and rear termination locations, the panels being positioned on left and right sides of the frame. The frame includes a vertical access for the rear cables and rear cable guides disposed within the frame. The frame further includes left and right vertical cable guides for patch cables. The frame further includes cable storage spools for the patch cables positioned adjacent to the left and right panels of the frame. The frame also includes a horizontal passage, linking the left and right panels and the cable guides. A lower portion of the frame defines splice tray holders and a central passage from the splice tray holders to the rear sides of the left and right panels. From a front of each panel, access to a rear of the panel is provided by the hinged panels.

### SUMMARY OF THE DISCLOSURE

Especially in the telecommunications industry fiber optic cables are used for the transmission of signals. To connect fiber optic equipment via fiber optic cables, fiber optic distribution modules have been developed. These fiber optic distribution modules are typically configured to be installed in fiber optic distribution racks, which typically comprise a rack extending vertically from a bottom to a top and are typically configured to receive a chassis with trays or individual slots, in which fiber optic distribution modules can be installed. Fiber optic distribution modules typically comprise a housing for storing over-length of fiber optic cables. The fiber optic cables often times comprise at least two cable segments, which are spliced together at a splice point. An incoming first fiber optic cable is typically connected to a second fiber optic cable, which may comprise pigtails which are connected to fiber optic connectors. The fiber optic cables can be in the form of single fibers or fiber optic ribbons.

Fiber optic ribbons usually comprise a number of optical fibers, which are typically connected to each other and formed into a flat strip. This is typically done by first manufacturing a series of individual optical fibers and laying them flat and bonding them to each other. By using this technology, typically as many as 36 optical fibers can be put together. The optic fibers are typically placed side by side forming a flat fiber optic ribbon. A special water resistant ribbon can be formed by an adhesive material which may be used to hold the fibers in place. Whenever installers have applications in a tight installation space, as is the case in many data centers, this type of cable typically can be one of the solutions. Because of the fiber optic ribbon cable design, fusion splicing becomes much easier, making it possible to splice several fibers altogether.

The trend of using fiber optic ribbon cables in data centers has therefore gained traction due to their compact design, e.g. lower diameters for higher fiber count cables and the possibility of mass-fusion splicing, e.g. 12 or more, for instance up to 24, fibers can be spliced together at once. These fiber optic ribbon cables are particularly beneficial for high-density environments, e.g. datacenters, hyperscale etc., where space optimization and installation efficiency are key factors. The present disclosure aligns with the goals of increasing installation efficiency when using fiber optic ribbon cables in data center applications. In combination with fiber optic distribution modules incorporated in a fiber optic equipment rack, typically in form of an optical distribution frame (ODF), the use of fiber optic ribbon cables increases the speed of installation which contributes to a notable reduction in overall installation time within a data center environment.

Although fiber optic ribbons offer the advantage to greatly reduce installation times in that the fibers are already sorted in the right order and several optic fibers can be spliced in one go (mass fusion splicing), the downside is that fiber optic ribbons are very sensitive to bending. These cables can only be bent in the direction of the flat part and not perpendicular to it. It is therefore difficult to place the fiber optic ribbons after splicing into small storage compartment without twists in the fiber optic ribbons. Especially in fiber optic distribution modules the optic fibers of the ribbon are typically attached at both ends, such that they cannot rotate freely.

Handling these sensitive fiber optic cables is time consuming, in particular with regard to the training of installers to assure proper handling without damaging the fibers.

Fiber optic cables in the form of fiber optic ribbons poses limited tolerances for bending. In particular twisting along the longitudinal direction of the fiber optic ribbon as well as bending with respect to the flat side has to be avoided. This conflicts with conventional routing of conventional fiber optic cables within fiber optic distribution modules. In particular, spliced fiber optic cables usually possess a significant free length of several decimeters to meters, typically in the range of up to 3 or 4 meters, between fiber entry port and fiber exit port. This over length is necessary to allow the splicing operation on a fiber optic splicing table. These workstations are typically placed in front of the fiber optic distribution rack to splice the first cable segment to the second cable segment. After the splicing operation, the over length is wound in form of loops and placed on the tray in the fiber management area. These loops are typically wound in form of opposite loops in form of the number eight (Arabic numeral).

This is however not possible with fiber optic ribbons, due to the resulting twisting of the cable when forming loops in the form of the number eight. To overcome this problem, it is possible to first wind the fiber optic cable in one direction (clockwise) and afterwards untwisting them by winding them in the other direction (anticlockwise), or vice versa. However, this is cumbersome and might damage the acrylate layer that holds the ribbonized fibers together as the twists first accumulate before they are finally released. Another common approach is to use larger storage compartments where only one loop of the optic fibers is needed. However, this contradicts the demand for higher density in data centers where more and more fibers have to fit into the available space.

One objective of the present disclosure can therefore be seen in facilitating and accelerating the storage of optic fibers, in particular fiber optic ribbons, in fiber optic distribution modules.

The present disclosure relates to a fiber optic distribution module assembly, in particular for installation in a fiber optic distribution rack. The fiber optic distribution module assembly typically comprises a fiber optic distribution module, which comprises a tray extending from a fiber entry port to a fiber exit port and comprising a fiber management area. The tray is typically essentially flat and can comprises guiding walls for guiding a fiber optic cable within the tray. To protect the optic fibers or fiber optic cable stored within the fiber optic distribution module, the fiber optic distribution module typically forms an installation space, which is completely enclosed. Completely enclosed is to be understood as enclosed except for at least one fiber entry port and at least one fiber exit port. The fiber optic distribution module can form an enclosure for the fiber management area between the fiber entry port and the fiber exit port with the enclosure being preferably formed by a bottom and sidewalls of the tray and a cover. The cover can be a cover plate which is connected to the tray after the optic fibers or fiber optic cable has been arranged within the tray. The cover plate can be mounted via latching or snap connections. By means of the tray and a releasable cover the installation space can be enclosed after the routing of the fiber optic cable and at the same time allow access to the fiber optic cable, e.g. for maintenance purposes.

The fiber entry port may be designed as a channel, which is arranged laterally at the fiber optic distribution module and mouths in the fiber management area, preferably in a curved manner. The channel can be tubular and comprise a receptacle for a corrugated tube. The receptacle can be in form of a groove, preferably in form of a number of circumferential grooves for receiving the corrugated tube in which at least one fiber optic cable is guided into the fiber optic distribution module. The fiber exit port can comprise an adapter configured for receiving at least one fiber optic connector, preferably in form of an array for multiple fiber optic connectors. The fiber optic cable, preferably in form of a fiber optic ribbon, can be split into individual fibers. Alternatively, the fiber optic ribbon could also be split into individual fibers during splicing. The array of adapters can be designed as a grid, comprising a number of plug-in places for receiving the fiber optic connectors. Typically standardized simplex or duplex connectors are used. The fiber entry port and the fiber exit port can be arranged adjacent to each other on one side of the fiber optic distribution module. Alternatively, the fiber entry port and the fiber exit port can be arranged opposite to each other with respect to the fiber management area, being preferably arranged at opposing sides of the fiber optic distribution module. The fiber entry port, fiber exit port and fiber management area can be arranged in one common plane, preventing the routed fiber optic able from bending or sagging.

In particular, for the installation in a fiber optic distribution rack, the fiber optic distribution module may comprise a hinge with connection means for preferably interconnecting the fiber optic distribution module with the fiber optic distribution rack. The goal is to use the existing space in fiber optic distribution racks as efficiently as possible. The fiber optic distribution modules are therefore usually stored in a stacked manner, each being arranged horizontally within a slot of the fiber optic distribution rack. To make the installation and maintenance easier for an installer, the fiber optic distribution modules can preferably be extracted from the fiber optic distribution rack and be moved from a horizontal storage position into a vertical mounting position. The fiber optic distribution module can be moved about the hinge from the horizontal position into a vertical mounting position. The fiber optic distribution module is thereby typically rotatable about 90 degrees, typically in a range between 80 degrees and 100 degrees. With the help of connection means the module can be connected to the fiber optic distribution rack. With a guiding system the fiber optic distribution module can be moved with regard to the fiber optic distribution rack from the mounting position to the final storage position within the rack.

The fiber optic distribution module assembly further comprises a fiber optic cable, preferably in form of a fiber optic ribbon, which is arranged within the fiber optic distribution module and extends from the fiber entry port via the fiber management area to the fiber exit port. The tray of the fiber optic distribution module typically comprises in the fiber management area holdings means for holding the fiber optic cable in place. The holdings means can be designed as L-shaped brackets for holding the fiber optic cable. The fiber optic cable typically comprises a first cable segment being fed into the fiber optic distribution module through the fiber entry port and being spliced at a splice point to at least one second cable segment which extends from the fiber exit port to the splice point. This allows that the fiber optic module can be preassembled with the at least one second cable segment being already preinstalled in the fiber optic equipment module. The at least one second cable segment can be in form of a fiber pigtail, preferably in form of a number of fiber pigtails, with a first end being connected to at least one fiber optic connector and a second end being spliced to the first cable segment at the splice point. Each first end of one of the pigtails may thereby be connected to a fiber optic connector and each of the second ends may be spliced to an optic fiber of the second cable segment, preferably in form of a fiber optic ribbon.

To overcome the problem of limited bending tolerances of fiber optic ribbons and to arrange the fiber optic cable with little tension, the fiber optic cable is in the fiber management area between the fiber entry port and the fiber exit port can be arranged in form of loops, whereby in a top view onto the tray at least one first loop extends from the fiber entry port towards the fiber exit port and is arranged clockwise, while at least a second loop extending form the fiber exit port towards the fiber entry port is arranged counterclockwise, or vice versa. This arrangement provides a simple and fast assembly without any movable parts and respects the minimal bending radius for the long-term storage of ribbons fibers without the need for a skilled installer of extensive training. This is an important aspect in view of the increasing demand for installers and a shortage of skilled labor, especially in the fast-growing data center market. Good results can be achieved when the number of first loops and the number of second loops is the same, with at least one first loop being wound in one direction and at least one second loop being wound in the other direction.

As described above noted, the fiber optic cable is typically formed by two cable segments, which are spliced together. The splice point is typically protected by a splice protector, which can be in form of a tubular sleeve, e.g. in form of a heat shrink tube. For arranging the splice protector, the tray may comprise a splice holder which is typically arranged in the fiber management area. The splice holder may comprise at least one slot for receiving at least one splice protector for protecting the splice point. The first cable segment, which typically extends between fiber entry port and splice point, may between the fiber entry port and the splice point be wound clockwise forming the first loops. The at least one second cable segment between the fiber exit port and the splice point may be wound counterclockwise forming the second loops, or vice versa. Winding the at least one first cable segment and the at least one second cable segment in opposite directions allows to lay the fiber optic cable from the fiber entry port to the fiber exit port without twisting the cable and thereby keeping the internal tensions within the fiber optic cable low.

To ensure that the at least one first loop and the at least one second loop after being arranged in the fiber management area remain in shape, the fiber management area may comprise holding means for the at least one first loop and the at least one second loop, for holding the first and second loop in place. Given that the fiber optic equipment module can be designed such that it can be moved about a hinge from a horizontal into a vertical position and vice versa, the holding means have to ensure that the loops are kept in place in both positions. The holdings means can therefore be designed as L-shaped brackets for holding the at least one first loop and the at least one second loop in place in both, a horizontal or a vertical orientation of the fiber optic distribution module. The L-shaped brackets form an undercut for receiving the first and second loops.

After the fiber optic cable has been spliced, winding of the first and second loops is a crucial part of the assembly process, as it is a delicate and time consuming process step. To simplify and fasten the winding, the present disclosure also relates to a mounting aid for the fiber optic distribution module assembly. The mounting aid typically comprises at least one ring-shaped spool for receiving a number of first and/or second loops of the fiber optic cable, and an interface for interconnecting the mounting aid to a fiber optic distribution module. In a preferred variation, the mounting aid comprises two ring-shaped spools, a first ring shaped spool for winding the at least one first loop and a second ring shaped spool for winding the at least one second loop. The ring shaped spool typically comprises a circumferential path around the spool on which the fiber optic cable, preferably a fiber optic ribbon, is arranged during winding. The path can be designed as a U-shaped groove, defined by the spool and therefrom extending protrusions.

The at least one ring-shaped spool may have a round, oval or polygonal cross section and retaining means, preferably in form of tongue shaped protrusions. The protrusions are typically arranged at least on one side of the ring shaped spool such that the fiber optic cable does not slip off the spool during winding. The ring-shaped spool may comprise a fixation means, preferably in form of a releasable rubber band and a removal opening, preferably arranged opposite to the fixation means. The removal opening may be designed as a recess, large enough for an installer to place the thumb to facilitate the removal of the loops wound on the spool. The fixation means in form of a rubber band can temporarily secure the loops on the ring-shaped spool and be removed for removing the loops.

For temporarily connecting the mounting aid to the fiber optic distribution module, the connection between the mounting aid and the fiber optic distribution module can be realized in form of a latching connection or a plug connection. For receiving the mounting aid, the fiber optic distribution module typically comprises an interface for interconnecting at least one mounting aid to the fiber optic distribution module, preferably through the latching connection or plug connection. The fiber optic distribution module typically comprises two interfaces, each for arranging one ring-shaped spool per interface. The interfaces are typically arranged adjacent to the fiber entry port respectively the fiber exit port. Alternatively, the fiber optic distribution module may comprise a mounting aid being integrally formed with the fiber optic distribution module. In case of a separate mounting aid, the fiber optic distribution module is typically provided as a kit of parts. The kit of parts typically comprises a fiber optic distribution module which comprises a tray extending from a fiber entry port to a fiber exit port and comprises a fiber management area. The kit also typically comprises a mounting aid which can comprise two ring-shaped spools, with the first ring-shaped spool typically being configured to receive a number of first loops of the fiber optic cable and the second ring-shaped spool being configured to receive a number of second loops of the fiber optic cable.

A method for assembling a fiber optic distribution module assembly, in particular an assembly as described herein above, typically comprises at least the following method steps:

Providing a fiber optic distribution module comprising a tray extending from a fiber entry port to a fiber exit port and comprising a fiber management area;

Providing a fiber optic cable, preferably in form of a fiber-optic ribbon, and arranging the fiber optic cable such that it extends from the fiber entry port to the fiber exit port;

Winding a free length of the fiber optic cable extending from the fiber entry port towards the fiber exit port into at least one first loop which in a top view onto the tray is wound clockwise and subsequently or simultaneously winding a free length of the fiber optic cable extending from the fiber exit port towards the fiber entry port to in at least one second loop which in a top view onto the tray is wound counterclockwise, or vice versa;

Optionally: Arranging the wound fiber optic cable in the fiber management area between the fiber entry port and the fiber exit port such that in a top view onto the tray the at least one first loop is arranged clockwise and the at least one second loop is arranged counterclockwise or vice versa.

In case that the fiber optic distribution module is assembled onsite, the fiber optic cable is typically spliced onsite as well. So instead of inserting a continuous fiber optic cable into the fiber optic distribution module, the following steps can be performed:

Providing a first cable segment of a fiber optic cable, which is fed into the fiber optic distribution module through the fiber entry port, and

Providing at least one second segment of a fiber optic cable, which extends from the fiber exit port into the fiber optic distribution module, and Splicing the first cable segment and the at least one second segment to each other at a splice point.

The first cable segment extending between the fiber entry port and the splice point can be either wound clockwise forming the first loop and the at least one second cable segment between the fiber exit port and the splice point can be wound counterclockwise forming the second loop, or vice versa. Before forming the first loop and the second loop, at least one mounting aid in form of a ring-shaped spool, in particular as described herein above, can be connected to the fiber optic distribution module via an interface. Preferably, two mounting aids are used and the at least one first loop is formed by winding the optical cable around the first of the two ring-shaped spools clockwise, and the at least one second loop is formed by winding the optical cable around the second of the two ring-shaped spools counterclockwise, or the at least one first loop is formed by winding the optical cable counterclockwise and the at least one second loop is formed by winding the optical cable clockwise.

The at least one first loop is typically removed from the first of the two ring-shaped spools and placed in the fiber management area while the at least one second loop remains on the second of the two ring-shaped spools, and the at least one second loop is removed from the second of the two ring-shaped spools, and placed in the fiber management area, and the mounting aids are removed from the fiber optic distribution module.

Alternatively, to the before mentioned method, the fiber optic distribution module assembly can also be assembled according to a method for assembling the fiber optic distribution module assembly wherein the at least one first loop and the at least one second loop are wound manually without the help of a mounting aid. The simultaneous winding of the fiber optic ribbons can also be performed by hand without a mounting aid by a well skilled and trained installer.

The product directly obtained by the before mentioned method is a fiber optic distribution module assembly, assembled after one of before mentioned method. Both, the foregoing features of the fiber optic distribution module and the fiber optic distribution module assembly and of the methods for assembling a fiber optic distribution module assembly can be used interchangeable. It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and installer of the concepts disclosed.

### BRIEF DESCRIPTION OF THE DRAWINGS

The herein described disclosure will be more fully understood from the detailed description given herein below and the accompanying drawings which should not be considered limiting to the disclosure described in the appended claims.

FIG. 1 shows a top view onto a first variation of the fiber optic distribution module assembly;

FIG. 2 shows a perspective view onto the first variation of the fiber optic distribution module assembly according to FIG. 1;

FIG. 3 shows a perspective view onto a kit of parts comprising the first variation of the fiber optic distribution module assembly according to FIG. 1 with a first variation of the mounting aid in an exploded view;

FIG. 4 shows a top view onto the kit of parts according to FIG. 3 with the mounting aid being mounted to the fiber optic distribution module;

FIG. 5 shows a top view onto the first variation of the mounting aid;

FIG. 6 shows a perspective view onto the mounting aid according to FIG. 5 in an exploded manner;

FIG. 7 shows a perspective view onto the first variation of the fiber optic distribution module assembly according to FIG. 1 in an assembled state with mounted cover;

FIG. 8 shows an illustration of the first assembly step of a first assembly method, attaching the mounting aid;

FIG. 9 shows an illustration of the second assembly step of a first assembly method, releasing the fixation means;

FIG. 10 shows an illustration of the third assembly step of a first assembly method, preparing the winding step;

FIG. 11 shows an illustration of the fifth assembly step of a first assembly method, the arranging the first and second cable segment on the mounting aid;

FIG. 12 shows an illustration of the sixth assembly step of a first assembly method, winding the first and second loops;

FIG. 13 shows an illustration of the seventh assembly step of a first assembly method, finishing the winding of the first and second loops;

FIG. 14 shows an illustration of the eight assembly step of a first assembly method, attaching the second loops by the fixation means;

FIG. 15 shows an illustration of the ninth assembly step of a first assembly method, removing the first loops from the mounting aid;

FIG. 16 shows an illustration of the tenth assembly step of a first assembly method, arranging the first loops in the tray;

FIG. 17 shows an illustration of the eleventh assembly step of a first assembly method, attaching the splice holder;

FIG. 18 shows an illustration of the twelfth assembly step of a first assembly method, arranging the second loops in the tray;

FIG. 19 shows an illustration of the thirteenth assembly step of a first assembly method, removing the mounting aid;

FIG. 20 shows an illustration of the first assembly step of a second assembly method, preparing the first segment for the winding;

FIG. 21 shows an illustration of the second assembly step of a second assembly method, manually winding the first loops;

FIG. 22 shows an illustration of the third assembly step of a second assembly method, attaching the splice holder and arranging the first loops in the tray;

FIG. 23 shows an illustration of the fourth assembly step of a second assembly method, manually winding the second loops;

FIG. 24 shows an illustration of the fifth assembly step of a second assembly method, arranging the second loops in the tray; and

FIG. 25 shows an illustration of the sixth assembly step of a second assembly method, inserting the fiber optic equipment tray in the rack.

### DESCRIPTION OF THE EMBODIMENTS

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

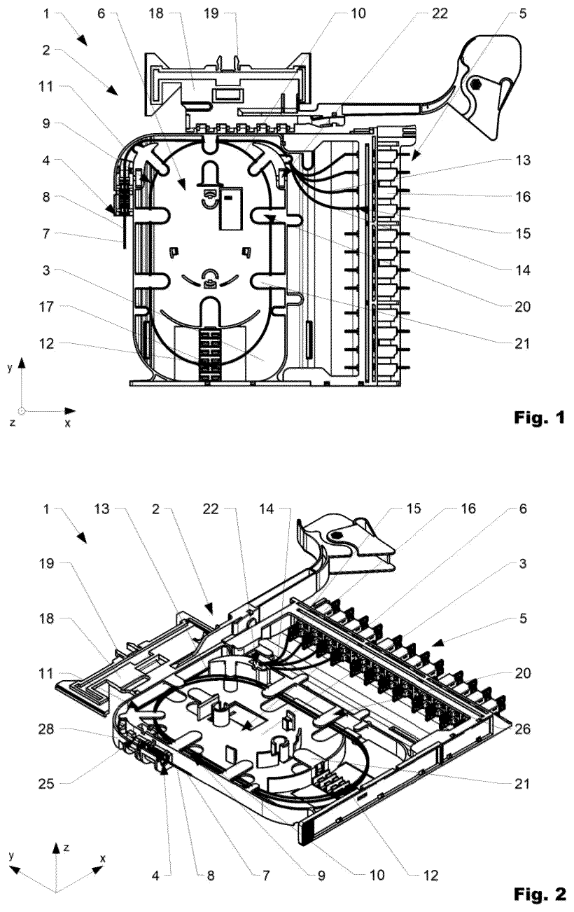

FIGS. 1 and 2 show a first variation of the fiber optic distribution module assembly 1, in FIG. 1 as a top view and in FIG. 2 as a perspective view. The shown fiber optic distribution module assembly 1, in particular for installation in a fiber optic distribution rack, comprises a fiber optic distribution module 2. The shown fiber optic distribution module 2 comprises an essentially flat tray 3, which extends from a fiber entry port 4 to a fiber exit port 5 and comprises a fiber management area 6. In the shown variation, the fiber entry port 4 and the fiber exit port 5 are arranged at opposite sides of the fiber optic distribution module 2.

The shown fiber optic distribution module assembly 1 comprises a fiber optic cable 7 in form of a fiber optic ribbon 8, which is arranged within the fiber optic distribution module 2 and extends from the fiber entry port 4 via the fiber management area 6 to the fiber exit port 5. The fiber optic cable 7 is in the fiber management area 6 between the fiber entry port 4 and the fiber exit port 5 arranged in form of loops 9, 10. In a top view onto the tray 3, a number of first loops 9 extend from the fiber entry port 4 towards the fiber exit port 5 and are arranged clockwise. A number of second loops 10 extend from the fiber exit port 5 towards the fiber entry port 4 and are arranged counterclockwise. Alternatively, the at least one first loop 9 and the at least one second loop 10 can also be arranged vice versa.

In the shown fiber optic distribution module assembly 1, the number of first loops 9 and the number of second loops 10 is the same. The shown fiber optic cable 7 comprises a first cable segment 11, which is fed into the fiber optic distribution module 2 through the fiber entry port 4. The first segment 11 is spliced at a splice point 12 to at least one second cable segment 13, which extends from the fiber exit port 5 to the splice point 12. The shown first cable segment 11 is between the fiber entry port 4 and the splice point 12 wound clockwise forming the first loops 9 and the at least one second cable segment 13 is between the fiber exit port 5 and the splice point 12 wound counterclockwise, forming the second loops 10. The at least one second cable segment 13 is in form of a fiber pigtail 14 with a first end 15 of each pigtail being connected to at least one fiber optic connector 16 and the second ends 17 of the pigtails are each spliced to a fiber of the first cable segment 11 at the splice point 12.

The shown fiber optic distribution module 2 comprises a hinge 18 with connection means 19 for interconnection of the fiber optic distribution module 2 with a fiber optic distribution rack. The shown fiber optic distribution module 2 is movable along the hinge 18 from a horizontal position into a vertical mounting position. The fiber management area 6 comprises holding means 20 for the at least one first loop 9 and the at least one second loop 10 for holding the first and second loop 9, 10 in place. The holding means 20 are designed as L-shaped brackets 21 for holding the at least one first loop 9 and the at least one second loop 10 in place in both, a horizontal or a vertical orientation of the fiber optic distribution module 2.

The fiber optic distribution module 2 comprises an interface 22 for interconnecting at least one mounting aid to the fiber optic distribution module 2, in the shown variation in form of latching connections or a plug connection. The shown fiber entry port 4 is designed as channel 25 being arranged laterally at the fiber optic distribution module 2 and mouths in the fiber management area 6, preferably in a curved manner. The fiber exit port 5 comprises an adapter 26 configured for receiving the at least one fiber optic connector 16, preferably in form of an array for multiple fiber optic connectors 16.

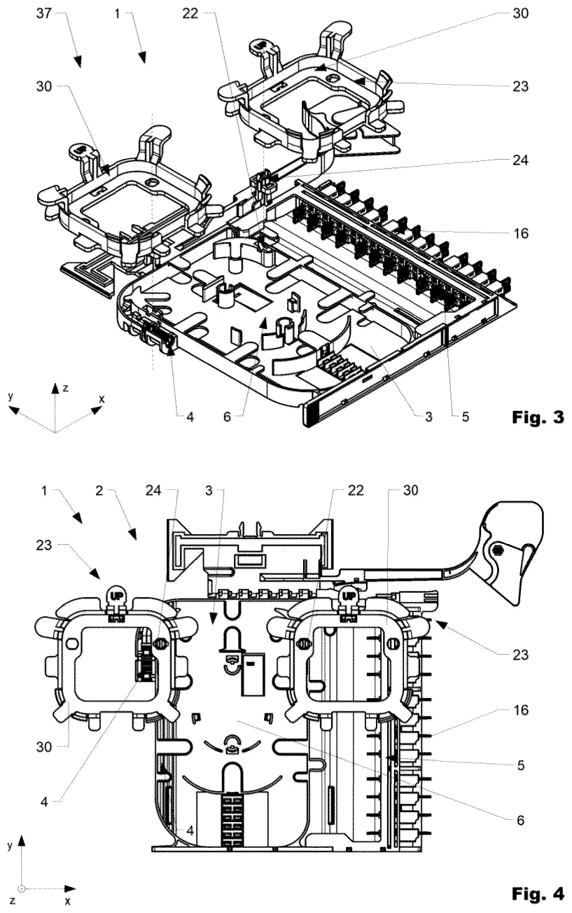

FIGS. 3 and 4 show the first variation of the kit of parts comprising a fiber optic distribution module assembly 1 as shown in FIGS. 1 and 2, with a first variation of a mounting aid 23. In FIG. 3 as a perspective exploded view and in FIG. 4 with the mounting aid being attached to the fiber optic distribution module assembly 1. The shown kit of parts 37 comprises a fiber optic distribution module 2, comprising a tray 3 extending from the fiber entry port 4 to the fiber exit port 5 and comprises a fiber management area 6, and a mounting aid 23, comprising two ring-shaped spools 30. The first ring-shaped spool 30 is configured to receive a number of first loops 9 of the fiber optic cable 7 and the second ring-shaped spool 30 is configured to receive a number of second loops 10 of the fiber optic cable 7.

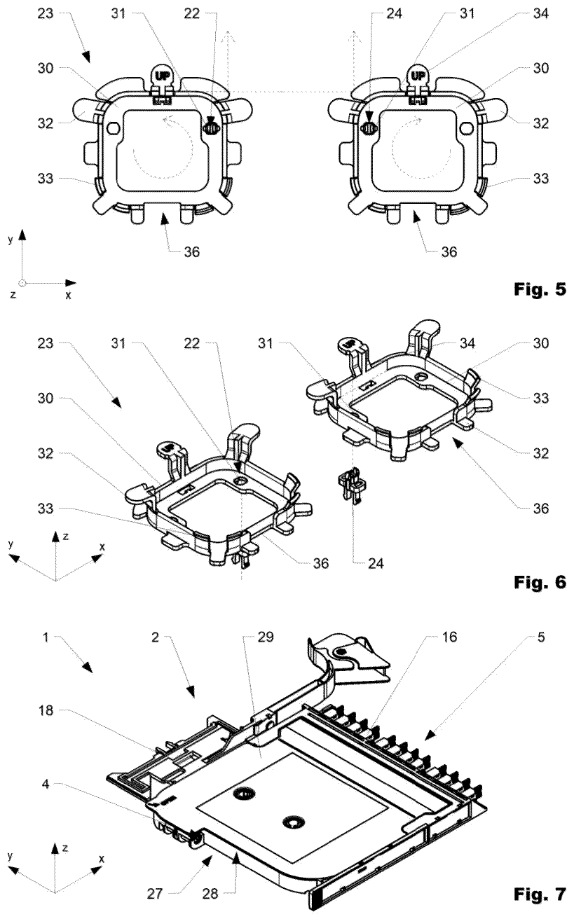

FIGS. 5 and 6 show the first variation of the mounting aid 23 in FIG. 5 as a top view and in FIG. 6 as an exploded perspective view onto the mounting aid 23. The shown mounting aid 23 for the fiber optic distribution module assembly 1 comprises two ring-shaped spools 30 for receiving a number of first and/or second loops of the fiber optic cable. The shown interface 31 for interconnecting the mounting aid 23 to the fiber optic distribution module comprises latches 24. The ring-shaped spools 30 each have a round, oval or polygonal cross section (in the figure square-shaped with rounded edges) and retaining means 32, in form of tongue shaped protrusions 33. The mounting aid 23 is connected to the fiber optic distribution module 2 via the latching connection or alternatively by a plug connection 24. The ring-shaped spools 30 also comprise a fixation means 34 in form of a releasable rubber band and a removal opening 36 arranged opposite to the fixation means 34.

FIG. 7 shows a perspective view onto the first variation of the fiber optic distribution module assembly 1 according to FIGS. 1 and 2 in an assembled state with mounted cover 29. The fiber optic distribution module 2 forms an enclosure for the fiber management area 6 between the fiber entry port 4 and the fiber exit port 5, the enclosure is formed by a bottom 27 and sidewalls 28 of the tray 3 and the cover 29.

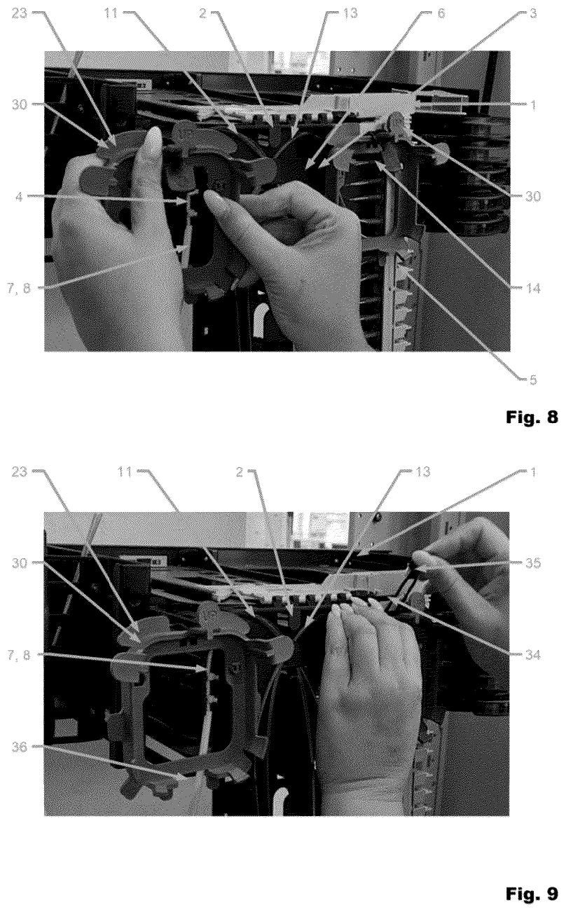

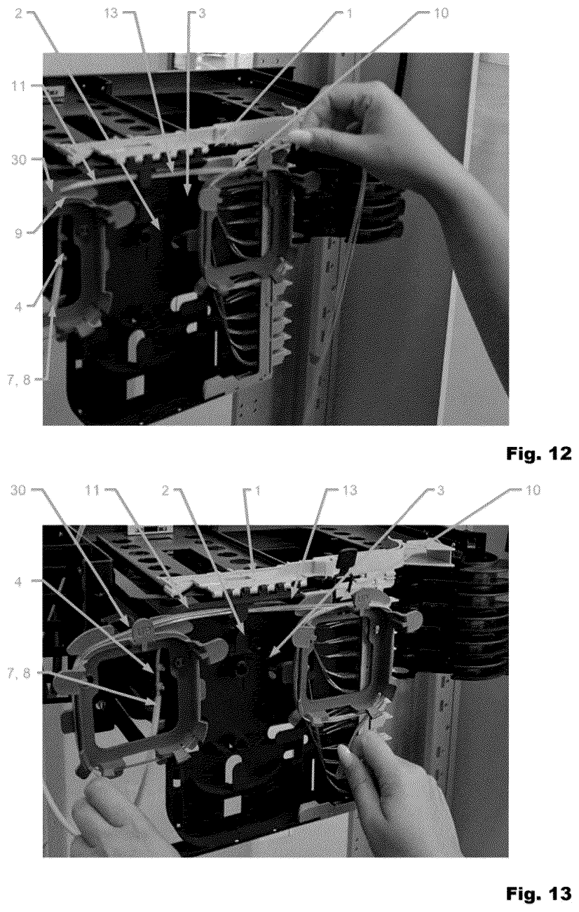

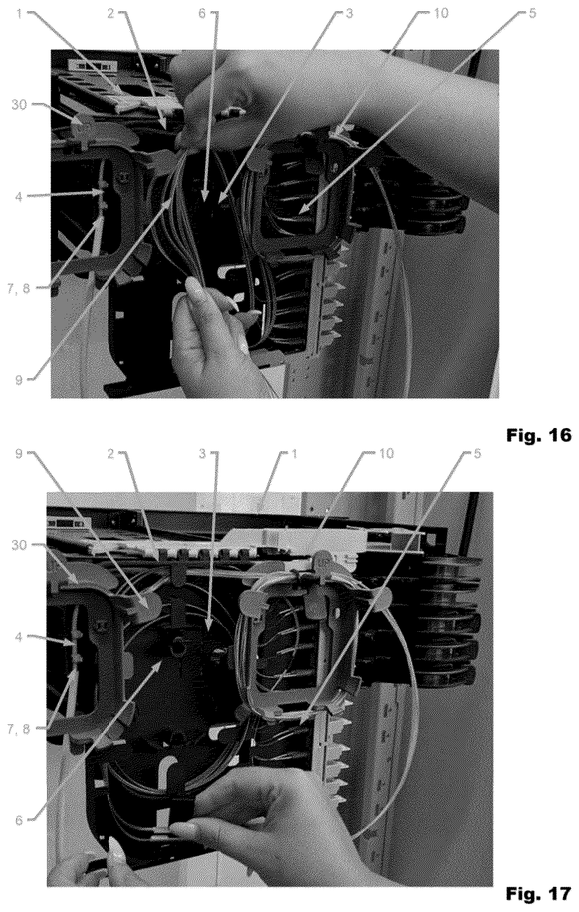

FIGS. 8 to 19 show a first assembly method for assembling the fiber optic distribution module assembly 1. For forming the first loop and the second loop, a mounting aid in form of two ring-shaped spools is connected to the fiber optic distribution module 2 by an operator via the interface.

FIG. 8 shows the assembly step of the mounting aid 23. The shown fiber optic distribution module 2 comprises a tray 3, which extends from the fiber entry port 4 to the fiber exit port 5 and comprises a fiber management area 6 being arranged there between. The fiber optic cable 7 in form of a fiber-optic ribbon 8 is arranged in the fiber optic distribution module 2, such that it extends from the fiber entry port 4 to the fiber exit port 5. The shown fiber optic cable 7 comprises a first cable segment 11, which has been fed into the fiber optic distribution module 2 through the tubular fiber entry port 4. The first cable segment 11 is then spliced to the second cable segment 13, which extends from the fiber exit port 5 into the fiber optic distribution module 2.

In the shown variation, the second cable segment 13 has been already pre-installed and the number of pigtails 14 have been already connected to the fiber optic connectors 16, which have also been pre-installed. After arranging the first cable segment 11 onsite, the first cable segment 11 and the second cable segment 13 have been spliced to each other at a splice point. For winding the first 11 and second 13 cable segment, the mounting aid 23 is attached to the fiber optic equipment module 2. The shown fiber optic equipment module 2 is depicted in the mounting position, which is the vertical position. The shown mounting aid 23 comprises two ring-shaped spools 30, which are releasable attached to the fiber optic equipment module 2 via the interface 22 by an installer onsite.

FIG. 9 shows releasing the fixation means 34 in form of a rubber band 35. The shown ring-shaped spools 30 each comprise a fixation means 34 in form of a releasable rubber band 35 and a removal opening 36, arranged opposite to the fixation means 34. The shown removal opening 36 is designed as a recess, large enough for the installer to place the thumb to facilitate the removal of the loops formed on the spool after the winding step. The fixation means 34 in form of a rubber band 35 are removed in this step by the installer before the winding step.

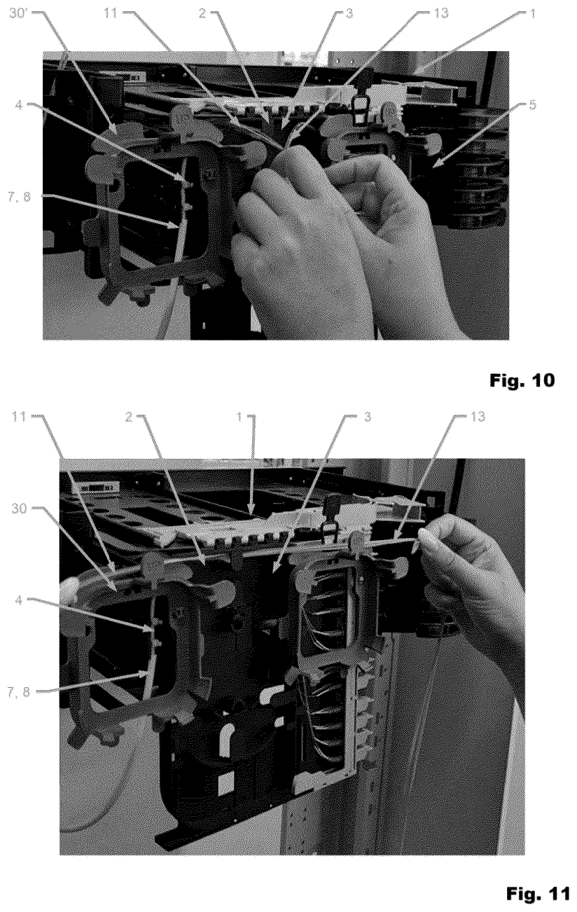

FIGS. 10 to 13 show the preparation of the first 11 and second 13 cable segment and the actual winding step. The first 11 and second 13 cable segments are taken by the installer and placed on the ring-shaped spools 30. A free length of the first cable segment 11 of the fiber optic cable 7, which extends from the fiber entry port 4 to the splice point, is wound about the first ring-shaped spool 30 (in the figures the left ring-shaped spool). A free length of the second cable segment 13 of the fiber optic cable 7 extending from the cable exit port 5 towards the splice point is wound about the second ring-shaped spool 30 (in the figures the right ring-shaped spool) into at least one second loop 10.

In the shown variation, in a top view onto the tray 3, the first loop 9 is wound clockwise and, simultaneously, the second loops 10 are in a top view onto the tray 3 wound counterclockwise. The spliced ribbon fibers are simultaneously wound in opposite directions around the two ring-shaped spools 30, such that twists from both sides are compensated for and do not accumulate along the fiber optic ribbon during winding.

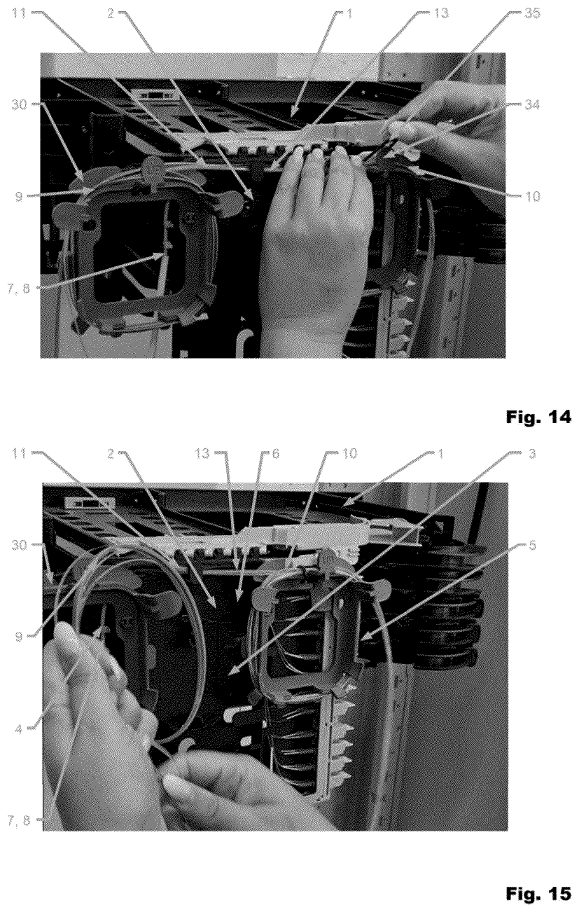

FIG. 14 shows attaching the first 11 and second loops 13 by the fixation means 34 in form of the rubber bands 35 to the respective ring-shaped spools 30. Before removing the first loops 9 from of the first one of the two ring-shaped spools 30, the second loops 10 on the other ring-shaped spool 30 are attached by means of the rubber band 35, after the winding step is concluded. This ensures that when removing the first loops 9, as shown by FIG. 15, the second loops 10 on the second ring-shaped spool 30 remain coiled.

FIGS. 15 to 17 show the arrangement of the first loops 9 in the fiber tray 4. The wound first loops 9 are arranged in the fiber management area 6 between the fiber entry port 4 and the fiber exit port 5, such that in a top view onto the tray 3 the at least one first loop 9 is arranged clockwise. The shown first loops 9 of the fiber optic ribbon are transferred from the ring-shaped spool 30 without any twists into the fiber management area. As can be obtained from FIG. 17 after placing the first loops 9 in the fiber management area 6, the splice holder with therein arranged splice protectors is mounted before also arranging the second loops 10 in the fiber management area 6.

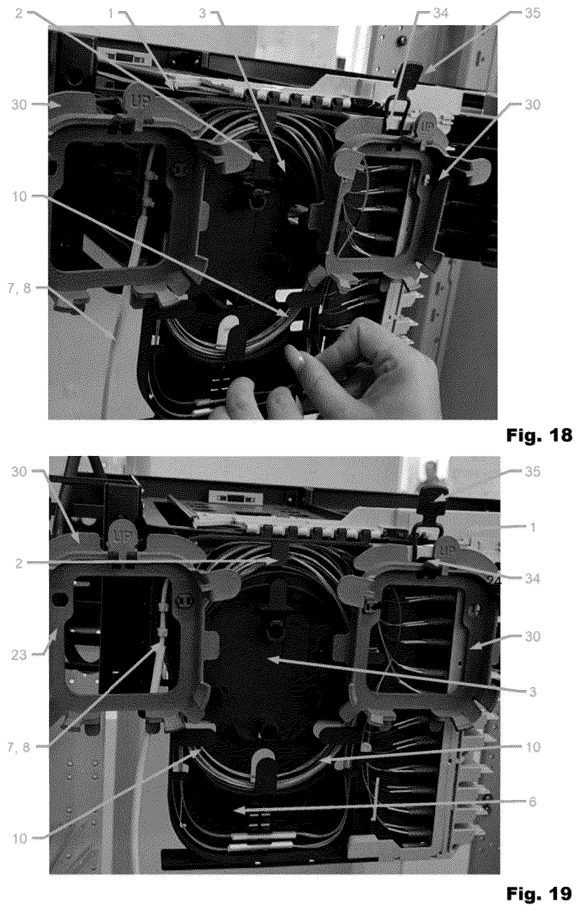

FIGS. 18 and 19 show the arrangement of the second loops 10 in the fiber tray 3. After releasing the fixation means 34 in form of a rubber band 35 of the second ring-shaped spool 30, the at least one second loop 10 is formed by winding the optical cable 7 around the second of the two ring-shaped spools 30 counterclockwise, or the at least one first loop 9 is formed by winding the optical cable 7 counterclockwise and the at least one second loop 10 is formed by winding the optical cable 7 clockwise.

The at least one second loop 10 is removed from the second of the two ring-shaped spools 30 and placed in the fiber management area 6. The mounting aids 23 are removed from the fiber optic distribution module 2. The shown mounting aid 23 can be either an integral part of the fiber optic distribution module 2 or can be removable. In the shown variation the ring-shaped spools 30 are removed before the fiber optic distribution module 2 is stored in the fiber optic rack, by moving the fiber optic distribution module 2 in the horizontal mounting position and sliding it into a respective slot in the rack.

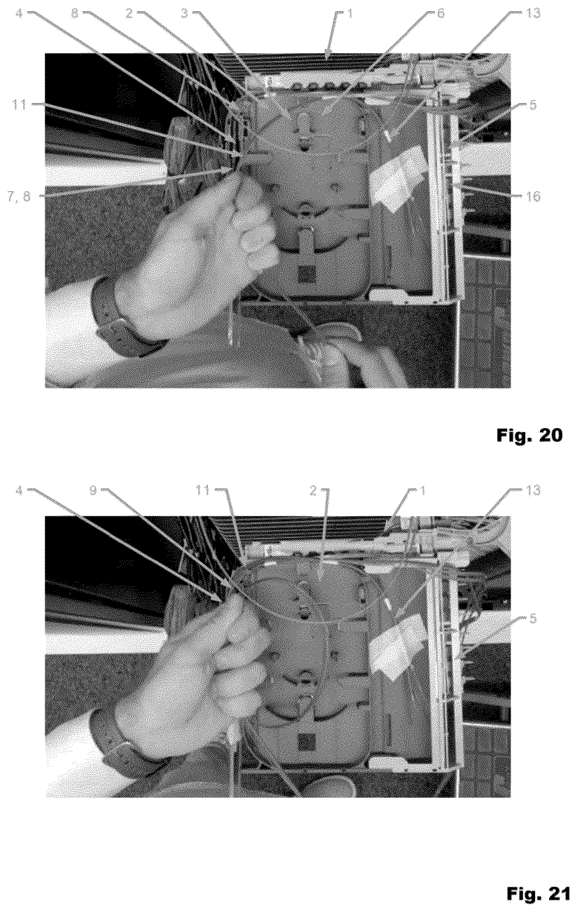

FIGS. 20 to 25 show a second assembly method for assembling the fiber optic distribution module assembly 1. The shown fiber optic distribution module 2 also comprises a tray 3, which extends from a fiber entry port 4 to a fiber exit port 5 and comprises a fiber management area 6 being arranged there between. A fiber optic cable 7 in form of a fiber-optic ribbon 8 is arranged in the fiber optic distribution module 2, such that it extends from the fiber entry port 4 to the fiber exit port 5. The shown fiber optic cable 7 comprises a first cable segment 11, which has been fed into the fiber optic distribution module 2 through the fiber entry port 4. The first cable segment 11 is spliced to a second cable segment 13, which extends from the fiber exit port 5 into the fiber optic distribution module 2.

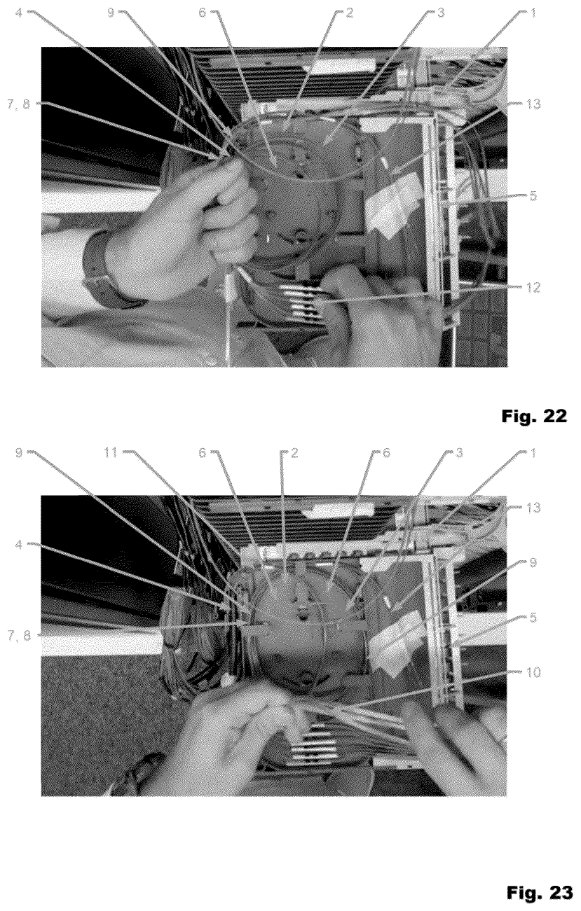

FIGS. 20 and 21 show the winding step for winding the first loops 9. The first cable segments 11 are taken by the installer and the free length of the first cable segment 11 of the fiber optic cable 7, which extends from the fiber entry port 4 to the splice point is wound manually without the help of a mounting aid. FIG. 22 shows that before placing the first loops 9 in the fiber management area 6, the splice holder with therein arranged splice protectors is mounted. FIG. 23 shows the winding step for winding the second loops 10. The second cable segments 13 are taken by the installer and the free length of the second cable segment 13 of the fiber optic cable 7, which extends form the fiber exit port 5 to the splice point is also wound manually without the help of a mounting aid.

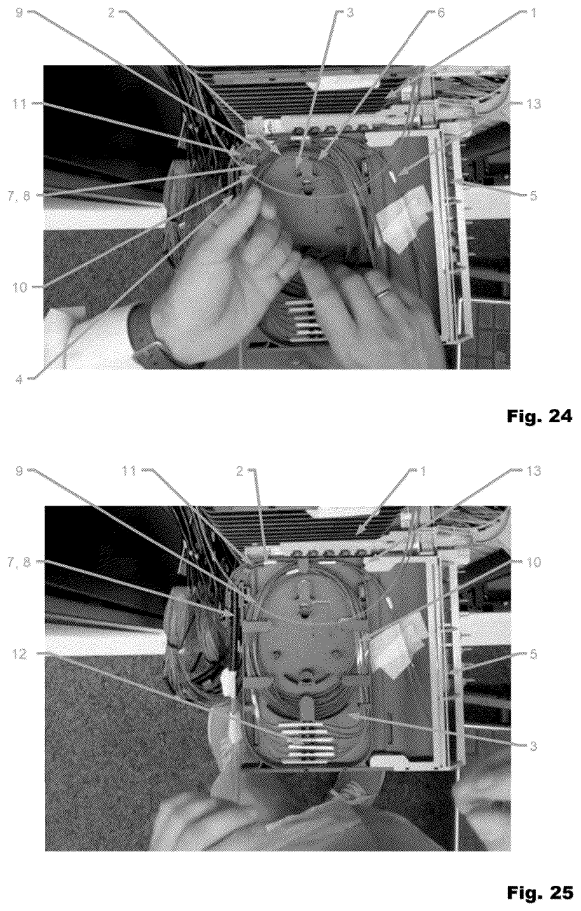

FIGS. 24 and 25 show the placement of the second loops 10 in the fiber management area 6, and in FIG. 25 the fully assembled fiber optic equipment assembly 1, before being slid into the fiber equipment rack.

Rather, the words used in the specification are words of description rather than limitation, and it is understood that various changes may be made without departing from the Spirit and scope of the disclosure.

1. A fiber optic distribution module assembly (1), for installation in a fiber optic distribution rack, the fiber optic distribution module assembly (1) comprising:
a. a fiber optic distribution module (2) comprising a tray (3) extending from a fiber entry port (4) to a fiber exit port (5) and comprising a fiber management area (6);
b. a fiber optic cable (7), preferably in form of a fiber optic ribbon (8), being arranged within the fiber optic distribution module (2) and extending from the fiber entry port (4) via the fiber management area (6) to the fiber exit port (5); and wherein
c. the fiber optic cable (7) is in the fiber management area (6) between the fiber entry port (4) and the fiber exit port (5) arranged in loops (9, 10) whereby in a top view onto the tray (3) at least one first loop (9) extending from the fiber entry port (4) towards the fiber exit port (5) is arranged clockwise and at least a second loop (10) extending from the fiber exit port (5) towards the fiber entry port (4) is arranged counterclockwise, or vice versa.

2. The fiber optic distribution module assembly (1) according to claim 1, wherein the number of first loops (9) and the number of second loops (10) is the same.

3. The fiber optic distribution module assembly (1) according to claim 1, wherein the fiber optic cable (7) comprises a first cable segment (11) being fed into the fiber optic distribution module (2) through the fiber entry port (4) and being spliced at a splice point (12) to at least one second cable segment (13) which extends from the fiber exit port (5) to the splice point (12).

4. The fiber optic distribution module assembly (1) according to claim 3, wherein the first cable segment (11) is between the fiber entry port (4) and the splice point (12) wound clockwise forming the first loops (9) and the at least one second cable segment (13) is between the fiber exit port (5) and the splice point (12) wound counterclockwise forming the second loops (10), or vice versa.

5. The fiber optic distribution module assembly (1) according to claim 1, wherein the at least one second cable segment (13) comprises a fiber pigtail (14) with a first end (15) being connected to at least one fiber optic connector (16) and a second end (17) being spliced to the first cable segment (11) at the splice point (12).

6. The fiber optic distribution module assembly (1) according to claim 1, wherein the fiber optic distribution module (2) comprises a hinge (18) with connection means (19) for interconnection of the fiber optic distribution module (2) with a fiber optic distribution rack.

7. The fiber optic distribution module assembly (1) according to claim 6, wherein the fiber optic distribution module (2) is movable along the hinge (18) from a horizontal position into a vertical mounting position.

8. The fiber optic distribution module assembly (1) according to claim 1, wherein the fiber management area (6) comprises holding means (20) for the at least one first loop (9) and the at least one second loop (10) for holding the first and second loop (9, 10) in place.

9. The fiber optic distribution module assembly (1) according to claim 8, wherein the holdings means (20) are designed as L-shaped brackets (21) for holding the at least one first loop (9) and the at least one second loop (10) in place in both, a horizontal or a vertical orientation of the fiber optic distribution module (2).

10. The fiber optic distribution module assembly (1) according to claim 1, wherein the fiber optic distribution module (2) comprises an interface (22) for interconnecting at least one mounting aid (23) to the fiber optic distribution module (2), preferably through a latching connection or a plug connection (24).

11. The fiber optic distribution module assembly (1) according to claim 1, wherein the fiber entry port (4) is designed as channel (25) being arranged laterally at the fiber optic distribution module (2) and mouths in the fiber management area (6), preferably in a curved manner.

12. The fiber optic distribution module assembly (1) according to claim 1, wherein the fiber exit port (5) comprises an adapter (26) configured for receiving the at least one fiber optic connector (16), preferably in form of an array for multiple fiber optic connectors (16).

13. The fiber optic distribution module assembly (1) according to claim 1, wherein the fiber optic distribution module (2) forms an enclosure for the fiber management area (6) between the fiber entry port (4) and the fiber exit port (5), the enclosure formed by a bottom (27) and sidewalls (28) of the tray (3) and a cover (29).

14. A mounting aid (23) for a fiber optic distribution module assembly (1), according to claim 1, the mounting aid (23) comprising:
a. at least one ring-shaped spool (30) for receiving a number of first and/or second loops (9, 10) of the fiber optic cable (7), and
b. an interface (31) for interconnecting the mounting aid (23) to a fiber optic distribution module (2).

15. The mounting aid (23) according to claim 14, wherein the at least one ring-shaped spool (30) has a round, oval or polygonal cross section and retaining means (32), preferably in form of tongue shaped protrusions (33).

16. The mounting aid (23) according to claim 14, wherein the connection between the mounting aid (23) the fiber optic distribution module (2) is a latching connection or a plug connection (24).

17. The mounting aid (23) according to claim 14, wherein the ring-shaped spool (30) comprises a fixation means (34), preferably in form of a releasable rubber band (35) and a removal opening (36), preferably arranged opposite to the fixation means (35).

18. A kit of parts (37) comprising:
a. a fiber optic distribution module (2) comprising a tray (3) extending from a fiber entry port (4) to a fiber exit port (5) and comprising a fiber management area (6), and
b. a mounting aid (23) according to claim 14, comprising two ring-shaped spools (30), with the first ring-shaped spool (30) being configured to receive a number of first loops (9) of the fiber optic cable (7) and the second ring-shaped spool (30) being configured to receive a number of second loops (10) of the fiber optic cable (7).

19. A method for assembling a fiber optic distribution module assembly (1), according to claim 1, the method comprising at least the following method steps:
a. providing a fiber optic distribution module (2) comprising a tray (3) extending from a fiber entry port (4) to a fiber exit port (5) and comprising a fiber management area (6);
b. providing a fiber optic cable (7), preferably in form of a fiber-optic ribbon (8), and arranging the fiber optic cable (7) such that it extends from the fiber entry port (4) to the fiber exit port (5); and
c. winding a free length of the fiber optic cable (7) extending from the fiber entry port (4) towards the fiber exit port (5) into at least one first loop (9) which in a top view onto the tray (3) is wound clockwise and subsequently or simultaneously winding a free length of the fiber optic cable (7) extending from the fiber exit port (5) towards the fiber entry port (4) to in at least one second loop (10) which in a top view onto the tray (3) is wound counterclockwise or vice versa.

20. The method according to claim 19 further comprising:
d. arranging the wound fiber optic cable (7) in the fiber management area (6) between the fiber entry port (4) and the fiber exit port (5) such that in a top view onto the tray (3) the at least one first loop (9) is arranged clockwise and the at least one second loop (10) is arranged counterclockwise or vice versa.

21. The method according to claim 19, wherein instead of step b. the following steps are performed:
a. providing a first cable segment (11) of a fiber optic cable (7), which is fed into the fiber optic distribution module (2) through the fiber entry port (4), and
b. providing at least one second segment (13) of a fiber optic cable (7), which extends from the fiber exit port (5) into the fiber optic distribution module (2);
c. splicing the first cable segment (11) and the at least one second segment (13) to each other at a splice point (12).

22. The method according to claim 19, wherein the first cable segment (11) between fiber entry port (4) and splice point (12) is wound clockwise forming the first loop (9) and the at least one second cable segment (12) is between the fiber exit port (5) and the splice point (12) wound counterclockwise forming the second loop (10), or vice versa.

23. The method according to claim 19, wherein before forming the first loop (9) and the second loop (10), at least one mounting aid (23) in form of a ring-shaped spool (30) is connected to the fiber optic distribution module (2) via an interface (31).

24. The method according to claim 23, wherein two mounting aids (23) are used and
a. the at least one first loop (9) is formed by winding the optical cable (7) around the first of the two ring-shaped spools (30) clockwise; and
b. the at least one second loop (10) is formed by winding the optical cable (7) around the second of the two ring-shaped spools (30) counterclockwise; or
c. the at least one first loop (9) is formed by winding the optical cable (7) counterclockwise and the at least one second loop (10) is formed by winding the optical cable (7) clockwise.

25. The method according to claim 24 comprising the following additional steps:
a. the at least one first loop (9) is removed from the first of the two ring-shaped spools (30) and placed in the fiber management area (6) while the at least one second loop (10) remains on the second of the two ring-shaped spools (30), and
b. the at least one second loop (10) is removed from the second of the two ring-shaped spools (30), and placed in the fiber management area (6), and
c. the mounting aids (23) are removed from the fiber optic distribution module (2).

26. The method for assembling a fiber optic distribution module assembly (1) according to claim 19, wherein the at least one first loop (9) and the at least one second loop (10) are wound manually without the help of a mounting aid (23).

27. A fiber optic distribution module assembly (1) to be assembled according to claim 19.
